(19) United States
(12) Patent Application Publication
(10) Pub. No.: US 2008/0206106 A1
(43) Pub. Date: Aug. 28, 2008

(54) Method and apparatus for rapidly concentrating particles for analysis of explosives

(76) Inventor: Juan Fernandez de la Mora, New Haven, CT (US)

Correspondence Address: Juan Fernandez de la Mora, 80 Cold Spring Street, New Haven, CT, 06511, US

(21) Appl. No.: 12/012,771

(22) Filed: Feb. 5, 2008

Related U.S. Application Data
(60) Provisional application No. 60/899,840, filed on Feb. 6, 2007.

(51) Int. Cl. G01N 7/00; G01N 21/00

(52) U.S. Cl. 422/83; 73/23.2

(57) ABSTRACT

A fast alternative for detecting dangerous or illegal substances is taught that improves upon the relatively slow conventional batch method of collecting and concentrating particles in filters. The new method concentrates the particles on-line and almost instantaneously, taking advantage of their inertia. Particles are thus concentrated on the fly from a large gas sample flow rate into a small gas flow rate, where they are rapidly volatilized and their vapors sensed in an analytical instrument such as a mass spectrometer or an ion mobility spectrometer.

### CROSS REFERENCE TO RELATED APPLICATION

This application claims the benefit of priority to U.S. Provisional Patent Application 60/899,840, filed on Feb. 5, 2007.

### REFERENCES

S. Fuerstenau, A. Gomez and J. Fernández de la Mora (1994) Visualization of aerodinamically focused aerosol jets, J. Aerosol Sci., 25, 165-173, 1994

### FIELD OF THE INVENTION

This invention relates to the field of explosive and illegal substance detection

### INTRODUCTION AND PRIOR ART

Detection of explosives and other dangerous or illegal substances is important to civilian and military security, and many devices have been developed and commercialized for such purposes. Examples include ion mobility spectrometers (IMS) used at airports, which ionize the vapors of the substances searched, and identify them according to their electrical mobility. Because many explosives have very low room temperature volatilities, even a large amount of exposed explosive yields gas phase concentrations too low to be detected by IMS instruments. Sensing them then requires achieving substantial increases of concentration above ambient values prior to IMS analysis. This is often attained by collecting small particles on the luggage or clothing from the person searched, via contact with a sampling cloth (swabbing), or by removal with gas jets. The solid or liquid particles thus sampled are then introduced in a heated region where they liberate vapors at concentrations much larger than the room temperature vapor pressure of the explosive, which often makes them readily detectable. This technique is very effective, but the sampling procedure is slow. As a result of this, only a small fraction of airplane passengers are currently searched at airport security points. An improvement of this technique has been available for several years, where sample concentration is achieved by passing a relatively large flow of gas through a medium, such as a filter capable of collecting most of the particles, and sometimes even the vapors. The material thus concentrated in the filter is subsequently heated, and the volatiles released are carried by a relatively small flow of gas into the IMS analyzer. This concentration system combined with a method to remove particles from airline passengers (by blowing various jets into them) and conveying this sample into the concentrator has become commercial (GE), and was deployed in a number of US airports in 2006. In spite of the success of this approach, it is still relatively slow (˜25 s/passenger) due to the need to sample a large flow rate of gas, collect for a certain period vapors and particles carried by that large flow, stop the large flow, heat up substantially the collected material such as to evaporate it, and convey the resulting vapors in a small flow into a sensing instrument. From the viewpoint of screening all passengers through these or similar portals, it would be most desirable to greatly accelerate the concentration process. Providing a method and an apparatus to do so is the objective of the present invention.

### BRIEF SUMMARY OF THE INVENTION

The invention uses particle inertia to concentrate particles of explosives or regulated substances on line, from a large sampling flow of hundreds or thousands of liters per second flow, into a much smaller sampling flow of the order of 1 lit/min, which is readily heated to evaporate the particles and is subsequently sent for vapor detection into a suitable instrument such as a mass spectrometer or an ion mobility spectrometer. In contrast to existing techniques for concentration of explosive particles, which involve relatively slow batch processes, the invention permits an almost instantaneous concentration and vapor release process

### BRIEF DESCRIPTION OF THE DRAWINGS

FIG. 1 is a schematic of a conventional virtual impactor

FIG. 2 is a schematic of a focusing virtual impactor

FIG. 3 is a block diagram of the system for on-line concentration, volatilization and analysis of the particles originally suspended in la large flow of gas

### MORE DETAILED DESCRIPTION OF THE INVENTION

We shall distinguish between the process of concentrating vapors, and that of concentrating particles. Vapors cannot be readily physically separated from the carrier gas at atmospheric pressure due to their small inertia. However, particles are easily separated from the gas due to their large inertia. Vapor concentration is probably the most desirable of the two processes discussed, but, due to its greater difficulty, it will not be considered here. This invention deals with particle concentration and detection, whose great importance is evident from the fact that it is the only concentrating process taking place in conventional and successful hand-swabbing systems used for IMS detection.

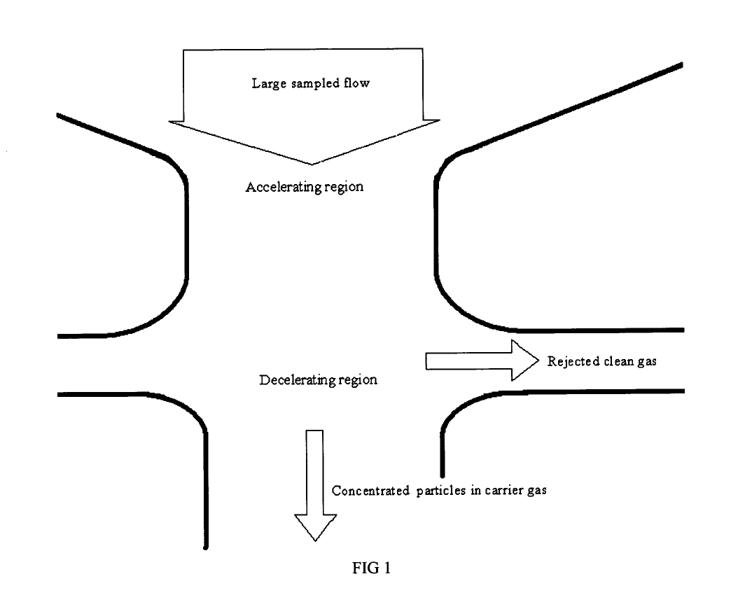

The phenomenon of inertial separation of particles from each other according to their size, or from a carrier gas in which they are suspended, is widely used in devices such as cyclones and impactors. In these, a stream of gas is accelerated to relatively high speeds, and then forced to decelerate abruptly, whereupon the gas is readily deflected, but not the particles. Virtual impactors are well known embodiments of this principle, as schematically shown in FIG. 1. They essentially involve an accelerating region (top), where a relatively large flow rate is formed into a jet, which impinges on an open sampling cavity (bottom). The jet carries much more flow of gas than is admitted through the cavity, so that most of the incoming gas is not sampled through it. However, proper selection of the flow parameters for a given particle size and density leads to passage of almost all the inflow of particles through the cavity. Since most particles pass into the cavity accompanied by a small fraction of the gas, the result is a large concentration of the original particles in the minor flow sampled through the cavity. One obvious advantage of this concentration scheme over the one based on sample accumulation on a filter or a getter material is that the concentration process now takes place almost instantly. A second advantage is that drastic concentration ratios by three orders of magnitude are achievable by one or at most two such impaction stages.

A first embodiment of this invention therefore involves simply the use of an on-line (continuous rather than batch operation) particle concentrator relying on particle inertia. Such devices already exist commercially, with an ability to concentrate particles in the size range from 1 μm to 10 μm, from a large initial flow rate in the range of 1000 lit/min, into an exit concentrated flow in the range of 1 lit/min. Those skilled in the art of virtual impactors can design similar instruments covering other ranges of desired flow rates, as well as larger or somewhat smaller particle sizes. Note however that the use of such existing devices for the application under consideration is by no means obvious, as evident from the fact that the slow concentrating system described, developed at SANDIA, has been in existence for a decade, and even after having been deployed commercially in airports, it still relies on the off-line (batch) slow concentration scheme rather than the fast on-line method here proposed.

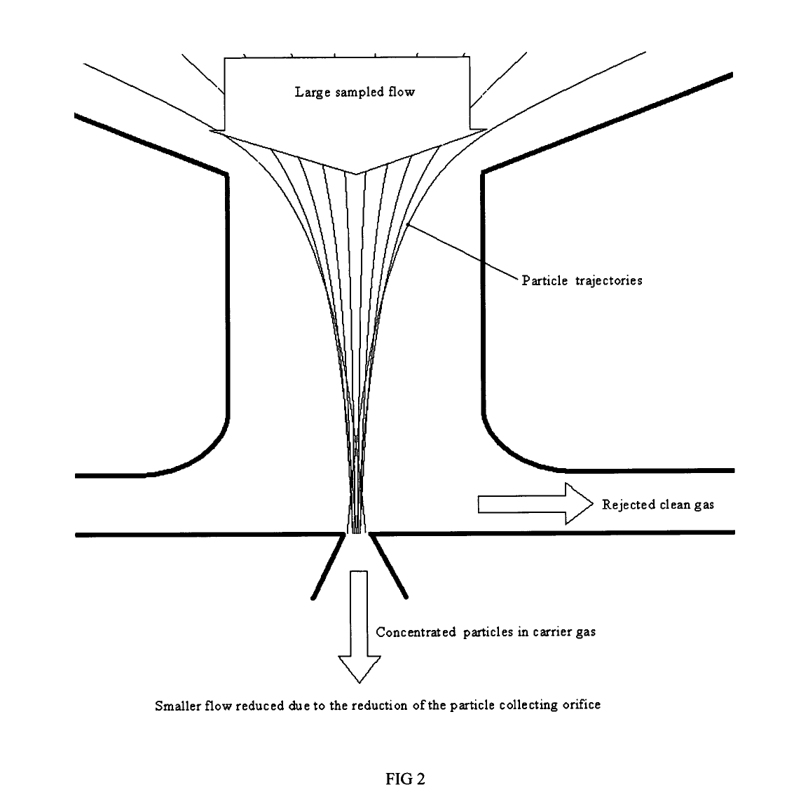

A second embodiment of the invention is more appropriate for the purpose of concentrating particles smaller than those conventionally handled by virtual impactors, whose diameters are typically larger than 1 μm. The need to concentrate submicron particles is not evident, as those familiar with explosives would note that typical particle sizes of explosives are considerably larger than 1 μm, often far larger than the ten microns that can presently be handled by virtual impactor concentrators. The key point here is that large particles are readily removed from surfaces, and settle rapidly to the ground, while small particles are much harder to remove from skin or cloth, and can also remain in suspension in the atmosphere for extended periods. Hence, a terrorist that has been manipulating an explosive, and become contaminated with its particles, can far more easily remove the large ones than the small ones. Jet sampling taking place at a security portal (puffers) will then most likely lift relatively small particles, and these will be less likely to be concentrated in existing virtual impactor concentrators. Another important consideration is that security depends not only on testing individual passengers, but also on testing the composition of the air in wider areas for more global threat detection. In this case, a large flow of gas would be continuously sampled from the ambient, and its contents analyzed for explosives. But because large particles settle rapidly, this scheme will tend to sample preferentially smaller particles. To complicate matters further, such global sampling sites generally need to be considerably more sensitive than passenger portals, simply because the sources will necessarily be more distant. Therefore, such samplers should preferably draw flow rates in the range of tens of thousands of liters/minute or more, rather than the 1000 liters/min previously quoted. Under such conditions, the 30 s time delay associated to filtering samplers would probably not be a problem. But the filter approach would be considerably less efficient than on-line inertial separation. Note in this respect that ordinary fans can generate air speeds of 30 m/s, whereby one with a cross section of 1 m² would pass a flow rate of 30,000 lit/min. A good diffuser on the flow line would enable recovery of 90% of the pressure drop used to accelerate further this stream. The same fan would then yield velocities of 95 m/s, at which sufficient inertial effects can be obtained to concentrate particles smaller than 1 μm. Even smaller particles can be enriched a thousandfold in a single stage via focusing concentrators, such as the one described by S. Fuerstenau, A. Gomez and J. Fernández de la Mora (1994) in J. Aerosol Sci., 25, 165-173, 1994, schematically shown in FIG. 2. The mai difference with conventional virtual impactors is that the relatively high convergence of the incoming gas flow leads to strong concentration of the particles into a focal region. As a result, the opening of the sampling orifice carrying the minor flow may be smaller than in virtual impactors. This enables capture of a large fraction of the particles in a certain range of sizes, while suctioning an unconventionally small fraction of the gas. The concentration factor is therefore unusually large. Note however that FIGS. 1 and 2 are meant to be descriptive of existing approaches achieving inertial concentration, while the present invention is not about specific methods to concentrate particles. What we intend to teach is the use of such methods to achieve unprecedented levels of sensitivity and measurement speed in security and related applications.

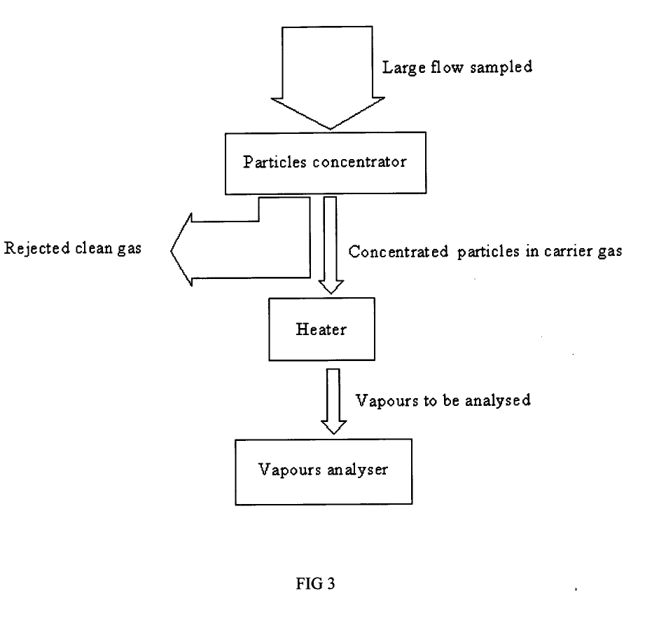

A block diagram of the invention is given schematically in FIG. 3. It consists of a stage of inertial concentration of particles, whereby a large flow rate of gas one wishes to analyze for explosives or dangerous substances is concentrated into a small gas flow in a first component of the system. This small gas flow, now highly concentrated in these particles, is subsequently heated, such that particles of interest are rapidly evaporated. Finally, these vapors are sampled into an analytical instrument suitable for detecting vapors. As a result of the relatively small flow rate delivered to the heater and analyzer by the concentrator, the volatilization process can occur continuously in a relatively small device. Similarly, an analytical instrument designed to sample a relatively small flow rate can handle the vapors from the particles coming from a much larger sample flow rate of ambient gas.

I claim:

1) A method for detecting substances having room temperature vapor pressures below 10⁻⁹ atmospheres, involving the following steps:
a) Continuously sampling a large flow of gas containing small particles of said substances
b) concentrating said particles continuously into a smaller flow of said sample gas by inertial separation
c) heating continuously said smaller flow of sample gas, such as to partially or fully evaporate said concentrated particles, yielding continuously the vapors of said substances having room temperature vapor pressures below 10⁻⁹ atmospheres
d) analyzing and detecting said vapors in a suitable analytical instrument

2) A method according to claim 1 where said substance has a room temperature vapor pressure below 10⁻¹⁰ atmospheres.

3) A method according to claim (1) where said inertial separation uses a virtual impactor

4) A method according to claim (1) where said inertial separation uses a focusing concentrator

5) A method according to claim (1) where said particles are smaller than 2 μm

6) A method according to claim (1) where said particles are smaller than 1 μm

7) A method according to claim (1) where said large flow of gas sampled exceeds 3000 lit/min

8) A method according to claim (1) where said suitable analytical instrument combines a scheme to ionize said vapors and a mass spectrometer

9) A method according to claim (1) where said suitable analytical instrument combines a scheme to ionize said vapors and an ion mobility spectrometer

10) A method according to claims 8 or 9 where said scheme to ionize said vapors involves the use of ionizing radiation, such as radioactive sources, or electromagnetic radiation.

11) A method according to claims 8 or 9 where said scheme to ionize said vapors involves the use of charged drops.
